(19) United States
(12) Patent Application Publication
(10) Pub. No.: US 2011/0056250 A1
(43) Pub. Date: Mar. 10, 2011

(54) Washing machine and detergent feeding device thereof

(75) Inventor: Jeom Gap Kim, Yongin-si (KR)

(73) Assignee: SAMSUNG ELECTRONICS CO., LTD., Suwon-si (KR)

(21) Appl. No.: 12/805,268

(22) Filed: Jul. 21, 2010

(30) Foreign Application Priority Data
Sep. 9, 2009 (KR) 10-2009-84894

(51) Int. Cl. D06F 35/00; B67D 7/78

(52) U.S. Cl. 68/17 R; 222/145.1

(57) ABSTRACT

The washing machine includes a detergent feeding device formed by integrally assembling a detergent box, a water feeding device, and valves. The washing machine further includes a printed circuit board and a pressure switch. The front surface of the detergent feeding device, which is inclined, is fixed to an inclined part of the front surface of the washing machine.

### CROSS-REFERENCE TO RELATED APPLICATIONS

This application claims the benefit of Korean Patent Application No. 2009-0084894, filed on Sep. 9, 2009 in the Korean Intellectual Property Office, the disclosure of which is incorporated herein by reference.

### BACKGROUND

1. Field

Embodiments relate to a washing machine having a detergent feeding device.

2. Description of the Related Art

In general, a washing machine is an apparatus which washes laundry by rotating a cylindrical spin basket containing laundry and wash water. Washing machines are divided into a drum washing machine in which a spin basket is horizontally arranged and laundry is washed by lifting the laundry and then dropping the laundry along the inner circumferential surface of the spin basket when the spin basket is rotated in regular and reverse directions on a horizontal axis, and a vertical axis washing machine in which a spin basket provided with a pulsator installed therein is vertically arranged and laundry is washed using a water current generated by the pulsator when the spin basket is rotated in regular and reverse directions on a vertical axis.

The drum washing machine includes a housing forming the external appearance of the washing machine, a cylindrical tub installed in the housing to contain wash water, a spin basket rotatably installed in the tub to wash laundry, a driving motor disposed at the rear of the tub to rotate the spin basket, and a door installed on the front surface of the housing.

A detergent feeding device, which is connected to the inside of a box-shaped casing in a drawer type, is generally installed at the upper portion of the drum washing machine, and a hose to supply wash water introduced from a valve to a detergent box is separately connected to the rear surface of the detergent feeding device.

### SUMMARY

Therefore, it is one aspect to provide a washing machine, which reduces manufacturing costs and increases production efficiency.

It is another aspect to provide an improved washing machine, into which a user conveniently puts a detergent and a fabric rinse.

Additional aspects will be set forth in part in the description which follows and, in part, will be apparent from the description, or may be learned by practice of the embodiments.

In accordance with one aspect, a washing machine includes a main body, and a detergent feeding device including a detergent box, a water feeding device connected to the detergent box to supply water to the detergent box, and valves connected to the water feeding device, wherein the water feeding device includes a water feeding device frame provided with at least one water feed channel to guide water from the valves to the detergent box, and the detergent box and the valves are connected through the water feeding device frame, and thus form one unit together with the water feeding device.

The water feeding device may further include a water feeding device cover to cover the water feeding device frame.

The water feeding device cover may include an inclined plane disposed above the detergent box and inclined upwardly from the front surface of the main body toward the upper surface of the main body.

The detergent feeding device may further include a printed circuit board connected with the water feeding device.

The detergent feeding device may further include guides to receive wires connected to the printed circuit board.

The detergent feeding device may further include a pressure switch connected with the water feeding device.

The detergent box may include a plurality of protrusions protruded from the bottom surface thereof.

The detergent box may further include a discharge hole formed through the bottom surface thereof, and a connection hose connected to the discharge hole.

In accordance with a further aspect, a washing machine includes a main body provided with an inclined part inclined upwardly from the front surface thereof to the upper surface thereof, a detergent box fixed to the main body, and a water feeding device connected to the detergent box so as to supply water to the detergent box, and is assembled with the detergent box into one assembly, the assembly being mounted on the main body, wherein the water feeding device includes a water feeding device frame provided with at least one water feed channel to supply water to the detergent box, and a water feeding device cover provided with an inclined plane corresponding to the inclined part of the main body and detergent inlets formed through the inclined plane.

The washing machine may further include at least one valve connected to the water feeding device frame.

The washing machine may further include a printed circuit board connected to the water feeding device frame.

In accordance with another aspect, a detergent feeding device includes a detergent box to contain a detergent, a water feeding device frame connected to the detergent box and provided with at least one water feed channel to guide water to the detergent box, a water feeding device cover connected to the upper surface of the water feeding device frame to form the at least one water feed channel together with the water feeding device frame, and at least one valve mounted on the water feeding device frame to control water supplied to the at least one water feed channel.

The water feeding device frame may include a reception part, on which a pressure switch is mounted.

The water feeding device frame may include a projecting part, on which a printed circuit board is mounted.

The water feeding device frame may include a gasket provided between the at least one valve and a reception part connected to the at least one valve to prevent water leakage.

The at least one water feed channel of the water feeding device frame may include a rib protruded parallel with a flow direction of wash water around a junction point.

The at least one water feed channel of the water feeding device frame may include at least one hole formed at the outside of the protruded rib.

The at least one water feed channel of the water feeding device frame may be formed in a structure having a double wall.

### BRIEF DESCRIPTION OF THE DRAWINGS

These and/or other aspects will become apparent and more readily appreciated from the following description of the embodiments, taken in conjunction with the accompanying drawings of which:

FIG. 1 a longitudinal-sectional view illustrating a washing machine in accordance with one embodiment;

FIG. 2 is an exploded perspective view illustrating a detergent feeding device in accordance with the embodiment;

FIG. 3 is an exploded perspective view illustrating connection among a detergent box, a water feeding device frame, and a water feeding device cover;

FIG. 4 is a partial rear perspective view of FIG. 2;

FIG. 5 is a perspective view illustrating the washing machine in accordance with the embodiment, in which the detergent feeding device is mounted on an upper portion of a cabinet;

FIG. 6 is a plan view of the water feeding device frame shown in FIG. 3;

FIG. 7 is a longitudinal-sectional view taken along the line II-II of FIG. 6;

FIG. 8 is an enlarged plan view of a front end part of FIG. 6;

FIG. 9 is a longitudinal-sectional view taken along the line I-I of FIG. 4; and

FIG. 10 is a view illustrating a state of using the washing machine in accordance with the embodiment, on which a drying machine is stacked.

### DETAILED DESCRIPTION

Reference will now be made in detail to the embodiments, examples of which are illustrated in the accompanying drawings, wherein like reference numerals refer to like elements throughout.

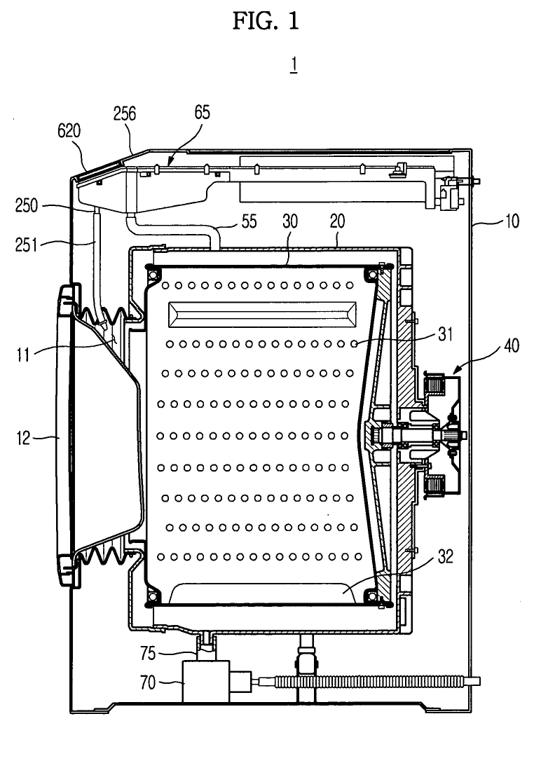

FIG. 1 a longitudinal-sectional view illustrating a washing machine in accordance with one embodiment.

As shown in FIG. 1, a washing machine 1 in accordance with the embodiment includes a cabinet 10 forming the external appearance of the washing machine 1, a tub 20 disposed in the cabinet 10, a drum 30 rotatably disposed in the tub 20, and a motor 40 to drive the drum 30.

An opening 11, through which laundry is put into the drum 30, is formed through the front surface of the cabinet 10. The opening 11 is opened and closed by a door 12 installed on the front surface of the cabinet 10.

A drain pump 70 and a drain pipe 75 to discharge water within the tub 20 to the outside of the cabinet 10 are installed below the tub 20.

A plurality of through holes 31 to circulate wash water is formed through the circumference of the drum 30, and a plurality of lifters 32 to lift and drop the laundry when the drum 30 is rotated is installed on the inner circumferential surface of the drum 30.

A detergent feeding device 65 including a detergent box 60, a water feeding device frame 61, a water feeding device cover 62, and valves 51, 52, 53, and 54, which are formed integrally, is mounted on the upper portion of the cabinet 10 of the washing machine 1. Ends of the valves 51, 52, 53, and 54 are connected to an external water supply source (not shown), and the other ends of the valves 51, 52, and 53 are connected to the detergent box 60 through the water feeding device frame 61.

Further, the detergent box 60 is connected to the tub 20 through a connection pipe 55.

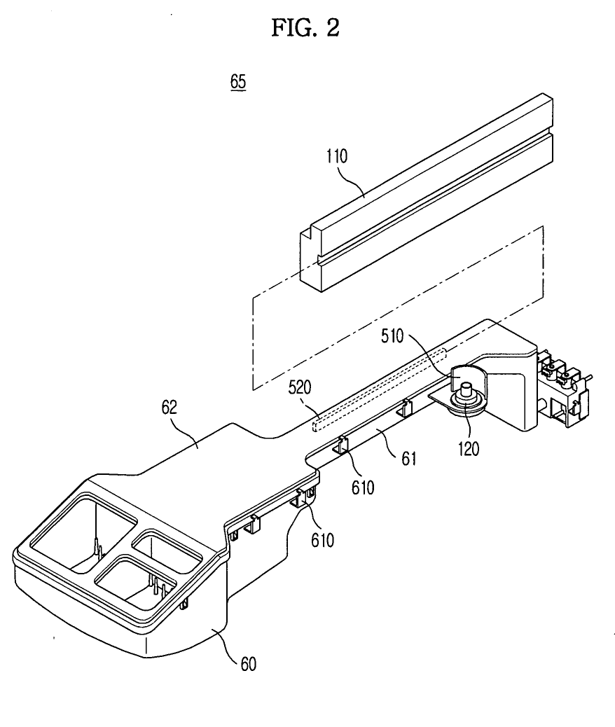

Wash water supplied through the valves 51, 52, and 53 is mixed with a detergent or a fabric rinse through water feed channels, formed by welding the water feeding device frame 61 and the water feeding device cover 62, and the detergent box 60, and then is supplied to the inside of the tub 20 (with reference to FIG. 2).

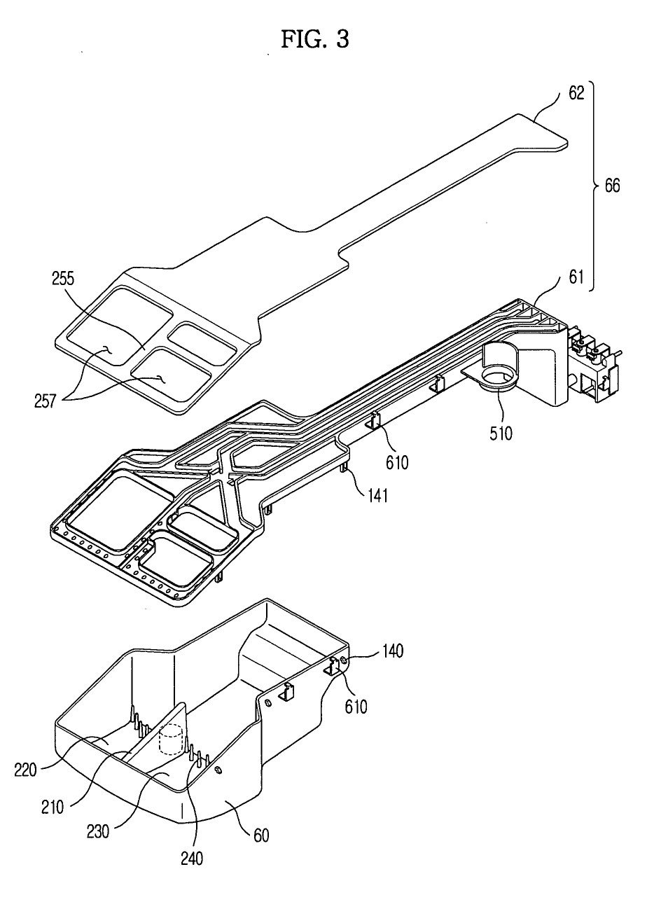

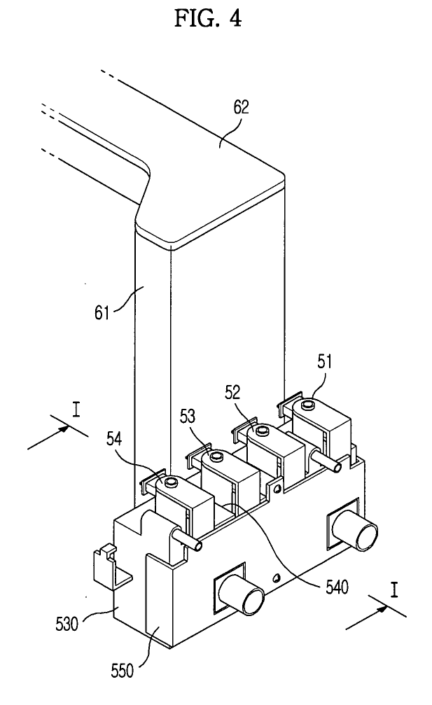

FIG. 2 is an exploded perspective view illustrating the detergent feeding device 65 in accordance with the embodiment, FIG. 3 is an exploded perspective view illustrating connection among the detergent box 60, the water feeding device frame 61, and the water feeding device cover 62, and FIG. 4 is a partial rear perspective view of FIG. 2.

As shown in FIGS. 2 and 3, the detergent box 60 and the water feeding device frame 61 are connected through insertion protrusions 140 and insertion holes 141 corresponding to the insertion protrusions 140, which are formed at the edges of the detergent box 60 and the water feeding device frame 61.

The water feeding device cover 62 is disposed on the upper surface of the water feeding device frame 61, and includes an inclined plane 255 inclined upwardly from the front surface to the upper of the cabinet 10 of the washing machine 1. Detergent inlets 257, through which the detergent and the fabric rinse are respectively put into the detergent box 60, are formed through the inclined plane 255.

The water feeding device cover 62 is welded onto the upper surface of the water feeding device frame 61, and thus the water feeding device frame 61 and the water feeding device cover 62 forms the water feed channels, along which water introduced through the valves 51, 52, and 53 flows.

That is, a water feeding device 66 is composed of the water feeding device frame 61 and the water feeding device cover 62, which are connected to each other.

The detergent box 60, the water feeding device frame 61, and the water feeding device cover 62 may be formed by injection molding.

As shown in FIGS. 2 to 4, a reception part 530 connected with the valves 51, 52, 53, and 54 is formed on the rear surface of the water feeding device frame 61.

The reception part 530 connected with the valves 51, 52, 53, and 54 and formed on the water feeding device frame 61 includes reception grooves 540 corresponding to the external shapes of the valves 51, 52, 53, and 54. The valves 51, 52, 53, and 54 are first fixed to a bracket 550 in a line, and then are inserted into the reception grooves 540 of the water feeding device frame 61. Thereafter, the bracket 550 and the water feeding device frame 61 are fixed to each other using screws, thereby preventing the valves 51, 52, 53, and 54 from being separated from the water feeding device frame 61.

As described above, the water feeding device frame 61 directly connects the detergent box 60 and the valves 51, 52, 53, and 54 through the plural insertion holes 141 connected with the detergent box 60 and the reception part 530 connected with the valves 51, 52, 53, and 54.

Since the detergent box 60 and the valves 51, 52, 53, and 54 are directly connected to each other, hoses for feeding water are not required, water leakage is minimized compared with a conventional connection type using hoses, and a clamping operation for fix hoses to the detergent feeding device and the valves 51, 52, 53, and 54 is omitted, thereby being capable of reducing manufacturing costs and increasing productivity.

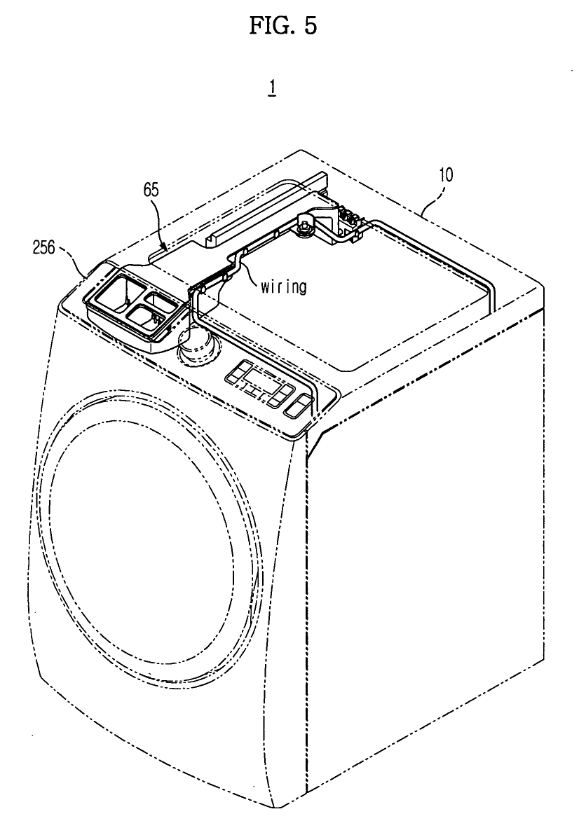

FIG. 5 is a perspective view illustrating the washing machine 1 in accordance with the embodiment, in which the detergent feeding device 65 is mounted on the upper portion of the cabinet 10.

As shown in FIG. 5, in accordance with the embodiment, the detergent feeding device 65 is formed by integrally assembling the detergent box 60, the water feeding device frame 61, the water feeding device cover 62, and the valves 51, 52, 53, and 54, and the detergent feeding device 65 are assembled into one assembly on the upper portion of the cabinet 10 of the washing machine 1.

The detergent feeding device 65 may further include a printed circuit board 110 or a pressure switch 120 connected to the water feeding device, and may further include guides 610 to guide wires connected to the printed circuit board 110.

Therefore, compared with a conventional structure in which respective parts are separately mounted on a cabinet of a washing machine and then are connected, such a structure of the detergent feeding device 65 in accordance with the embodiment is simply assembled and simplifies a wiring operation, thus improving productivity.

As shown in FIG. 3, the front surface of the detergent box 60 is inclined upwardly, and the inside of the detergent box 60 is divided into a space 220 to contain a detergent used in a main-washing course and a space 230 to contain a detergent used in a pre-washing course and a fabric rinse used in a rinsing course by a rib 210 installed in the detergent box 60.

The bottom surface of the detergent box 60 is U-shaped in order to prevent the detergent put into the detergent box 60 from remaining on the bottom surface of the detergent box 60 instead of the mixture of the detergent and water being introduced into the tub 20.

Further, protrusions 240 to minimize introduction of foreign substances or lumps of the detergent to the tub 20 may be formed on the bottom surface of the detergent box 60.

For example, if a user's ring enters the detergent box 60 while putting the detergent into the detergent box 60, the ring is caught by the protrusions 240 and is not introduced to the tub 20.

Further, the detergent may frequently lump in the detergent box 60, and the lumps of the detergent may not dissolve in water and may be introduced to the tub 20 through the connection pipe 55, thereby damaging laundry. In this case, the protrusions 240 obstruct movement of the lumps of the detergent and thus prevent the lumps of the detergent from being introduced to the connection pipe 55, or apply impact to the moving lumps of the detergent and thus reduce the sizes of the lumps of the detergent, thereby minimizing damage to the laundry.

As shown in FIG. 1, a discharge hole 250 may be formed through the bottom surface of the detergent box 60 so as to cause water to be dropped to the upper portion of the door 12.

If residual detergent or lint remains on the upper portion of the door 12 of the washing machine 1 after washing, water is dropped to the upper portion of the door 12 through the discharge hole 250, thus removing the residual detergent of the lint.

Further, since the length of the discharge hole 250 is restricted, a hose 251 to guide water to the upper portion of the door 12 of the washing machine 1 may be selectively inserted into the discharge hole 250.

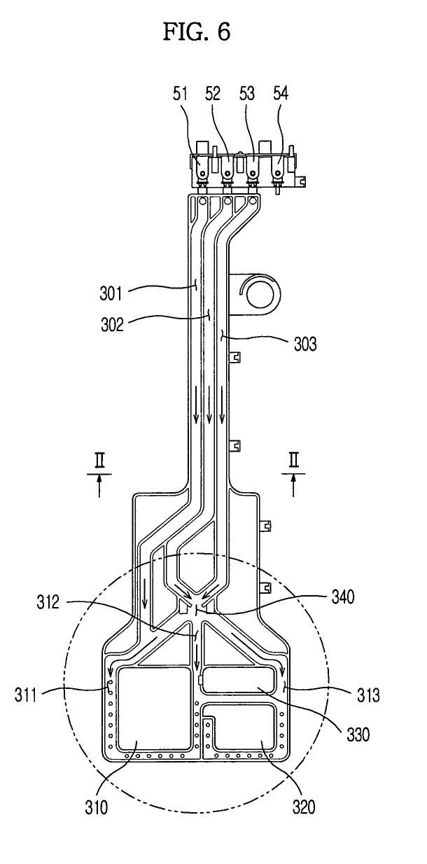

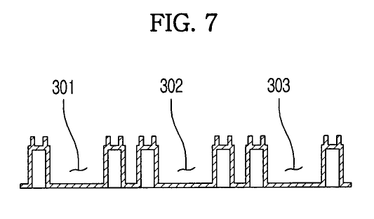

FIG. 6 is a plan view of the water feeding device frame 61 shown in FIG. 3, and FIG. 7 is a longitudinal-sectional view taken along the line II-II of FIG. 6.

As shown in FIG. 6, the water feed channels to allow wash water introduced from the valves 51, 52, 53, and 54 to flow into the detergent box 60 are formed on the water feeding device frame 61.

Wash water supplied from the first valve 51 is introduced to a space 310, in which the detergent used in the main-washing course is contained, through a water feed channel 301 and a water feed channel 311.

Wash water supplied from the second valve 52 is introduced to a space 320, in which the detergent used in the pre-washing course is contained, through a water feed channel 302 and a water feed channel 313.

Wash water supplied from the third valve 53 is introduced to the space 310, in which the detergent used in the main-washing course is contained, through a water feed channel 303 and the water feed channel 311.

Wash water supplied from the second valve 52 and wash water supplied from the third valve 53 respectively flow into the water feed channel 302 and the water feed channel 303, are combined at a junction point 340, and then are introduced to a space 330, in which a fabric rinse is contained, through a water feed channel 312.

As shown in FIG. 7, the water feed channels provided on the water feeding device frame 61 may be formed by double walls in order to minimize external impact or impact due to water pressure.

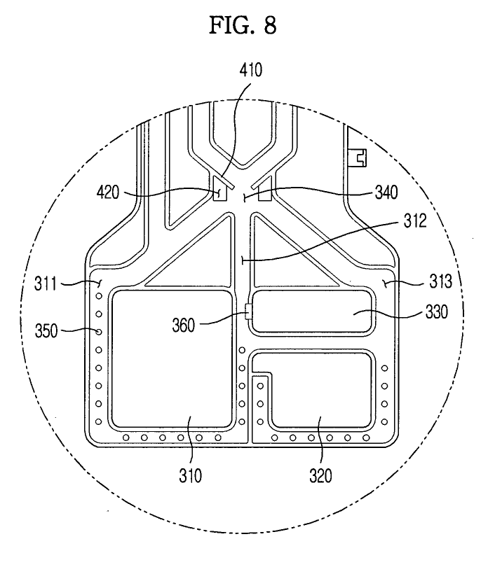

FIG. 8 is an enlarged plan view of the front end part of FIG. 6. As shown in FIG. 8, protruded ribs 410 extended from the external walls of the water feed channel 302 and the water feed channel 303 may be further formed at the junction point 340.

The protruded ribs 410 prevent a backflow of water to an undesired water feed channel, if the pressure of water introduced from the valves 51, 52, 53 and 54 is less than a designated value.

Further, holes 420 located at the outsides of the protruded ribs 410 may be further formed at the junction point 340.

A part of water supplied through the water feed channel 302 or the water feed channel 303 may not flow to the water feed channels 311, 312, and 313, but may stagnate at the junction point 340. In this case, the part of water may disturb the continuous progress of wash water, and thus is discharged through the holes 420 at the outsides of the protruded ribs 410.

Wash water supplied through the water feed channels 311 is introduced to the space 310, in which the detergent used in the main-washing course is contained, through a plurality of holes 350 formed on the water feeding device frame 61, is mixed with the detergent in the space 310, and then is introduced to the tub 20 containing laundry through the connection pipe 55.

Further, wash water supplied through the water feed channel 313 is introduced to the space 320, in which the detergent used in the pre-washing course is contained, through the plurality of holes 350 formed on the water feeding device frame 61, is mixed with the detergent in the space 320, and then is introduced to the tub 20 containing laundry through the connection pipe 55.

Further, wash water supplied through the water feed channel 312 is introduced to the space 330, in which the fabric rinse is contained, through an inlet 360 separately provided rather than through the plurality of holes 350 formed on the water feeding device frame 61.

The plurality of holes 350 is formed along the circumferences of the space 310, in which the detergent used in the main-washing course is contained, and the space 320, in which the detergent used in the pre-washing course is contained, and prevents the detergents from being accumulated at the circumferences of the spaces 310 and 320 without dissolution in water.

As shown in FIGS. 2 and 4, a reception part 510, on which the pressure switch 120 is mounted, may be further formed on one side surface of the water feeding device frame 61. The pressure switch 120 senses water pressure in the tub 20, and adjusts an amount of water supplied from the valves 51, 52, 53, and 54.

A projecting part 520, on which the printed circuit board 110 is mounted, may be further formed on the other side surface of the water feeding device frame 61. The printed circuit board 110 controls the motor 40, the valves 51, 52, 53, and 54, and the pressure switch 120 according to instructions input by a user through a control panel (not shown).

By fixing the printed circuit board 110 directly to the water feeding device frame 61, wires reaching the valves 51, 52, 53, and 54 have reduced lengths and the printed circuit board 110 is located at a height equal to or higher than the height of the valves 51, 52, 53, and 54, and it is not necessary to separately manufacture a cover to protect the printed circuit board 110 from water, thereby reducing manufacturing costs and increasing productivity.

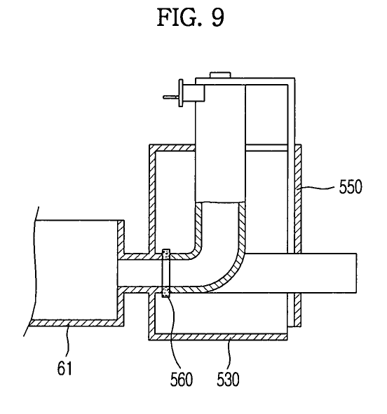

FIG. 9 is a longitudinal-sectional view taken along the line I-I of FIG. 4. As shown in FIGS. 4 and 9, the valves 51, 52, 53, and 54 are first fixed to the bracket 550 in a line, and then are inserted into the reception part 530 of the water feeding device frame 61. Here, a gasket 560 to prevent water leakage may be interposed between the water feeding device frame 61 and each of the valves 51, 52, and 53. The bracket 550 is also fixed to the water feeding device frame 61, and thus prevents the valves 51, 52, 53, and 54 from being separated from the water feeding device frame 61.

As shown in FIGS. 2, 3, and 5, the guides 610 to receive wires from the printed circuit board 110, the valves 51, 52, 53, and 54, and the pressure switch 120 may be further provided on the detergent box 60 and the water feeding device frame 61.

The guides 610 provided on the detergent box 60 and the water feeding device frame 61 collectively receive the wires from the printed circuit board 110, the valves 51, 52, 53, and 54, and the pressure switch 120, thereby causing an easy wiring effect.

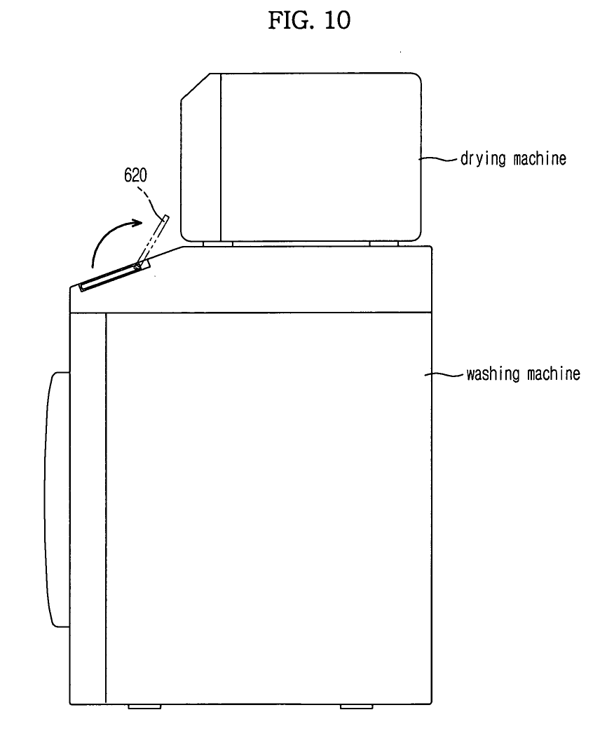

FIG. 10 is a view illustrating a state of using the washing machine in accordance with the embodiment, on which a drying machine is stacked. As shown in FIGS. 5 and 10, the front surface of the detergent feeding device 65 is inclined upwardly, and is fixed to the inclined plane of the front surface of the cabinet 10 of the washing machine 1.

Therefore, the detergent feeding device 65 in accordance with the embodiment of the present invention allows a user to stably and conveniently put a detergent and a fabric rinse into the detergent box 60 at a low angle without shaking, compared with a conventional drawer-type detergent feeding device, and does not have the possibility of mixing the detergent and the fabric rinse due to the fixed detergent box 60. Further, even if a drying machine is stacked on the washing machine, the detergent box 60 may be easily used without interference between a door 620 of the detergent feeding device 65 and the drying machine.

The door 620 is provided on the inclined plane 255 of the water feeding device cover 62, and serves to prevent the detergent or the fabric rinse, put into the detergent box 60, from being taken out of the detergent box 60.

As is apparent from the above description, in a washing machine and a detergent feeding device thereof in accordance with one embodiment, a detergent box, a water feeding device, and valves are integrally assembled into the detergent feeding device, thereby reducing manufacturing costs and increasing production efficiency of the detergent feeding device.

Further, the detergent feeding device is located on an inclined plane of the upper portion of the washing machine, thereby allowing a user to conveniently put a detergent and a fabric rinse into the detergent feeding device.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A washing machine comprising:
a main body; and
a detergent feeding device including a detergent box, a water feeding device connected to the detergent box to supply water to the detergent box, and valves connected to the water feeding device,
wherein the water feeding device includes a water feeding device frame provided with at least one water feed channel to guide water from the valves to the detergent box; and
the detergent box and the valves are connected through the water feeding device frame, and thus form one unit together with the water feeding device.

2. The washing machine according to claim 1, wherein the water feeding device further includes a water feeding device cover to cover the water feeding device frame.

3. The washing machine according to claim 2, wherein the water feeding device cover includes an inclined plane disposed above the detergent box and inclined upwardly from the front surface of the main body toward the upper surface of the main body.

4. The washing machine according to claim 1, wherein the detergent feeding device further includes a printed circuit board connected with the water feeding device.

5. The washing machine according to claim 4, wherein the detergent feeding device further includes guides to receive wires connected to the printed circuit board.

6. The washing machine according to claim 1, wherein the detergent feeding device further includes a pressure switch connected with the water feeding device.

7. The washing machine according to claim 1, wherein the detergent box includes a plurality of protrusions protruded from the bottom surface thereof.

8. The washing machine according to claim 7, wherein the detergent box further includes a discharge hole formed through the bottom surface thereof, and a connection hose connected to the discharge hole.

9. A washing machine comprising:
a main body provided with an inclined part inclined upwardly from the front surface thereof to the upper surface thereof;
a detergent box fixed to the main body; and
a water feeding device connected to the detergent box so as to supply water to the detergent box, and is assembled with the detergent box into one assembly, the assembly being mounted on the main body,
wherein the water feeding device includes a water feeding device frame provided with at least one water feed channel to supply water to the detergent box, and a water feeding device cover provided with an inclined plane corresponding to the inclined part of the main body and detergent inlets formed through the inclined plane.

10. The washing machine according to claim 9, further comprising at least one valve connected to the water feeding device frame.

11. The washing machine according to claim 9, further comprising a printed circuit board connected to the water feeding device frame.

12. A detergent feeding device comprising:
a detergent box to contain a detergent;
a water feeding device frame connected to the detergent box and provided with at least one water feed channel to guide water to the detergent box;
a water feeding device cover connected to the upper surface of the water feeding device frame to form the at least one water feed channel together with the water feeding device frame; and
at least one valve mounted on the water feeding device frame to control water supplied to the at least one water feed channel.

13. The detergent feeding device according to claim 12, wherein the water feeding device frame includes a reception part, on which a pressure switch is mounted.

14. The detergent feeding device according to claim 12, wherein the water feeding device frame includes a projecting part, on which a printed circuit board is mounted.

15. The detergent feeding device according to claim 12, wherein the water feeding device frame includes a gasket provided between the at least one valve and a reception part connected to the at least one valve to prevent water leakage.

16. The detergent feeding device according to claim 12, wherein the at least one water feed channel of the water feeding device frame includes a rib protruded parallel with a flow direction of wash water around a junction point.

17. The detergent feeding device according to claim 12, wherein the at least one water feed channel of the water feeding device frame includes at least one hole formed at the outside of the protruded rib.

18. The detergent feeding device according to claim 12, wherein the at least one water feed channel of the water feeding device frame is formed in a structure having a double wall.

19. The detergent feeding device according to claim 14, wherein the printed circuit board is mounted on the projecting part at a height equal to or higher than a height of the at least one valve.

20. The detergent feeding device according to claim 14, wherein the detergent box and water feeding device frame include guides to receive wires from the printed circuit board.
